(19) United States
(12) Patent Application Publication
(10) Pub. No.: US 2016/0338411 A1
(43) Pub. Date: Nov. 24, 2016

(54) BATTERY STICK AND ELECTRONIC CIGARETTE HAVING SAME

(71) Applicant: KIMREE HI-TECH INC., Tortola (VG)

(72) Inventor: Qiuming Liu, Shenzhen, Guangdong (CN)

(21) Appl. No.: 15/112,176

(22) PCT Filed: Jan. 16, 2014
(86) PCT No.: PCT/CN2014/070742

§ 371 Date: Jul. 16, 2016

(51) Int. Cl. A24F 47/00; H01R 4/28; H01M 2/08

(52) U.S. Cl. CPC A24F 47/008; H01M 2/08; H01R 4/28; H01M 2220/30

(57) ABSTRACT

The invention is related to a battery stick, one end of the battery stick is provided with an air inlet hole; the other end of the battery stick is provided with a first lower electrode used for electrically connecting to a atomizer; the first lower electrode is provided with a vent channel in communication with the air inlet hole; an air inlet of the vent channel is in communication with the air inlet hole; an air outlet of the vent channel is arranged on the side of the first lower electrode; an oil-blocking surface is formed on the top surface of the first lower electrode. The battery stick of the present invention can prevent non-vaporized electronic cigarette oil in the atomizer from entering the interior of the battery stick. Also provided is an electronic cigarette having the battery stick.

### TECHNICAL FIELD

The present application relates to an electronic heating product, and more particularly relates to an electronic cigarette.

### BACKGROUND

The electronic cigarette generally utilizes the battery in the battery stick to supply power for the heating component and products heat, makes the smoke oil in the atomizer to be atomized to produce smoke for users to inhale, and is used for smoking cessation or replacing the cigarette. Thus, two electrode connectors of the heating component are needed to connect to the anode and the cathode of the battery, respectively. And the oil guide rope of the heating component is needed to discharge the smoke oil in the oil storage chamber to realize atomizing the smoke oil by the heat wire of the heating component.

As shown in FIG. 1, an electronic cigarette in prior art comprises an atomizer 1 and a battery stick 2 connected to the atomizer 1. The atomizer 1 is provided with an air flow channel 3 used for smoke flow. One end of the battery stick 2 is provided with an air inlet hole 4. The other end of the battery stick 2 is provided with a first lower electrode 6 used for electrically connecting to the atomizer 1. The first lower electrode 6 is provided with a vent channel 8 communicated with the air inlet hole 4. The vent channel 8 and the air flow channel 3 are coaxial connected. When the oil guide rope of the atomizer 1 discharge too much smoke oil and the oil does not completely atomize, the non-vaporized smoke oil gathers into droplets. Under the influence of its own gravity, the droplets fall into the battery stick 2 through the air flow channel 3. Since the vent channel 8 in the first lower electrode 6 of the battery stick 2 and the air flow channel 3 are coaxial connected, the fallen droplets fall into the components of the battery stick 2 such as the battery and the sensor through the vent channel 8 in the first lower electrode 6, then it is easy to cause the short-circuit fault to the interior of the battery stick 2 to reduce the quality of the electronic cigarette.

### SUMMARY

The purpose of the present invention is, aiming at the defects in the prior art that the non-vaporized smoke oil easily falls into the interior of the battery stick, providing a battery stick and an electronic cigarette having the battery stick. The battery stick can prevent the non-vaporized smoke to fall into the interior of the battery stick.

In one aspect, the present invention provides a battery stick, used to form a electronic cigarette with an atomizer; one end of the battery stick is provided with an air inlet hole; the other end of the battery stick is provided with a first lower electrode used for electrically connecting to an atomizer; the first lower electrode is provided with a vent channel in communication with the air inlet hole; an air inlet of the vent channel is in communication with the air inlet hole; an air outlet of the vent channel is arranged on the side of the first lower electrode; an oil-blocking surface is formed on the top surface of the first lower electrode; the oil-blocking surface is used for preventing non-vaporized electronic cigarette oil in the atomizer from entering the vent channel.

In one embodiment, the vent channel comprises a first lower vent channel which is formed by extending along the opposite side of the air outlet, and a second lower vent channel which is communicated with the first lower vent channel and extended to the bottom of the first lower electrode; the second lower vent channel is communicated with the air inlet hole.

In the embodiment, the battery stick further comprises a second lower electrode which is arranged on the outside of the first lower electrode, and an insulation ring which arranged between the second lower electrode and the first lower electrode; an oil discharge hole is arranged on the second lower electrode and is communicated with the vent channel; the oil discharge hole is used for discharging the non-vaporized electronic cigarette oil.

In the embodiment, an oil storage gap is formed between the insulation ring and the second lower electrode; the oil storage gap is used for storing the non-vaporized electronic cigarette oil; the oil storage gap is communicated with the oil discharge hole.

In the embodiment, the distance between the oil discharge hole and the atomizer is larger than the distance between the air outlet and the atomizer.

In the embodiment, the battery stick further comprises a battery sleeve and a battery which is accommodated in the battery sleeve; the battery sleeve is fixedly connected to the second lower electrode; the battery is electrically connected to the first lower electrode.

In the embodiment, the battery stick further comprises a battery support; the battery is fixed in the battery sleeve by the battery support.

In the embodiment, the second lower electrode is a hollow cylindrical structure; a catch part is formed along a circle of the inner wall of the second lower electrode and used to catch the insulation ring; the catch part and the insulation ring are caught with each other and form the oil storage gap; the oil discharge hole is arranged on a side wall of the second lower electrode and is communicated with the oil storage gap.

In the embodiment, the second lower electrode further comprises a first connection part which is connected to the atomizer, a second connection part which is connected to the battery sleeve, and a third connection part between the first connection part and the second connection part; the oil discharge hole is arranged on an end of the first connection part near the third connection part.

In other embodiment, the battery stick further comprises a light emitting device which is arranged on an end of the battery sleeve away from the atomizer.

In another embodiment, the battery stick further comprises an atomization control unit which is arranged in the battery sleeve and is used to power on or power off the atomizer.

In other aspect the present invention further provides an electronic cigarette, comprises an atomizer and a battery stick which is connected to the atomizer, the battery stick is the above mentioned one.

In one embodiment, the electronic cigarette further comprises a decoration sleeve which is arranged on a joint between the atomizer and the battery stick; an oil discharge gap is formed between an end face of the decoration sleeve near the battery stick and the battery stick, and is used for discharging the non-vaporized electronic cigarette oil from the decoration sleeve.

In this embodiment, the atomizer further comprises a first upper electrode which is connected to the first lower electrode; the first upper electrode is accommodated in an atomization sleeve; an air flow channel is formed inside the first upper electrode and is communicated with the vent channel.

In this embodiment, the atomizer further comprises a second upper electrode which is arranged on the outside of the first upper electrode and is electrically insulated with the first upper electrode; the second upper electrode is detachably connected to the battery stick.

In another aspect, the present invention further provides an electronic cigarette, comprises an atomizer and a battery stick, one end of the battery stick is provided with an air inlet hole; the other end of the battery stick is provided with a first lower electrode used for electrically connecting to an atomizer; the first lower electrode is provided with a vent channel in communication with the air inlet hole; an air flow channel is formed inside the atomizer and is used for air flow, the air flow channel is communicated with the vent channel;

an air inlet of the vent channel is in communication with the air inlet hole; an air outlet of the vent channel is arranged on the side of the first lower electrode; the vent channel comprises a first lower vent channel which is formed by extending along the opposite side of the air outlet, and a second lower vent channel which is communicated with the first lower vent channel and extended to the bottom of the first lower electrode; the second lower vent channel is communicated with the air inlet hole;

an oil-blocking surface is formed on the top surface of the first lower electrode; the oil-blocking surface is used for preventing non-vaporized electronic cigarette oil in the atomizer from entering the vent channel.

The beneficial effects of implementing the present invention are: The battery stick provide in the present invention, by arranging the air outlet of the vent channel of the first lower electrode on the side of the first lower electrode while setting the top surface of the first lower electrode to be closed, when the first lower electrode applies this structure, after the non-vaporized smoke oil falls through the air flow channel, the closed top surface can prevent the fallen smoke oil. And since the air outlet is arranged on the side of the first lower electrode, the fallen non-vaporized smoke oil will not fall into the vent channel through the air outlet, thus the non-vaporized smoke oil can be prevented to fall into the interior of the battery stick through the vent channel.

Furthermore, the second lower electrode is provided with an oil discharge hole, the fallen non-vaporized smoke oil can be discharged, and the fallen non-vaporized smoke oil is further prevented to enter the battery stick.

### BRIEF DESCRIPTION OF THE DRAWINGS

The invention will be further described with reference to the accompanying drawings and embodiments in the following.

FIG. 1 is a schematic diagram of an electronic cigarette in prior art;

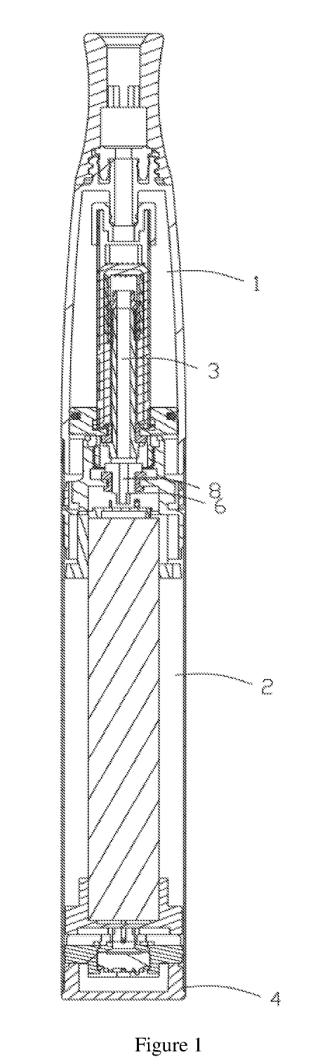

FIG. 2 is a schematic diagram of an electronic cigarette provided in the present invention;

FIG. 3 is an enlarged view of the element A in FIG. 2;

FIG. 4 is an exploded view of the battery stick in FIG. 2;

FIG. 5 is a schematic diagram of the second lower electrode in FIG. 4;

FIG. 6 is a schematic diagram of the first lower electrode in FIG. 4.

### DETAILED DESCRIPTION OF THE PREFERRED EMBODIMENT

The battery stick provide in the present invention, by arranging the air outlet of the vent channel of the first lower electrode on the side of the first lower electrode while setting the top surface of the first lower electrode to be close, when the first lower electrode applies this structure, after the non-vaporized smoke oil falls through the air flow channel, the close top surface can prevent the fallen smoke oil. And since the air outlet is arranged on the side of the first lower electrode, the fallen non-vaporized smoke oil will not fall into the vent channel through the air outlet, thus the non-vaporized smoke oil can be prevented to fall into the interior of the battery stick through the vent channel. Furthermore, the second lower electrode is provided with an oil discharge hole, the fallen non-vaporized smoke oil can be discharged, and the fallen non-vaporized smoke oil is further prevented to enter the battery stick.

In this embodiment, the end of the battery stick near the atomizer is the top end, the end of the battery stick far away from the atomizer is the bottom end.

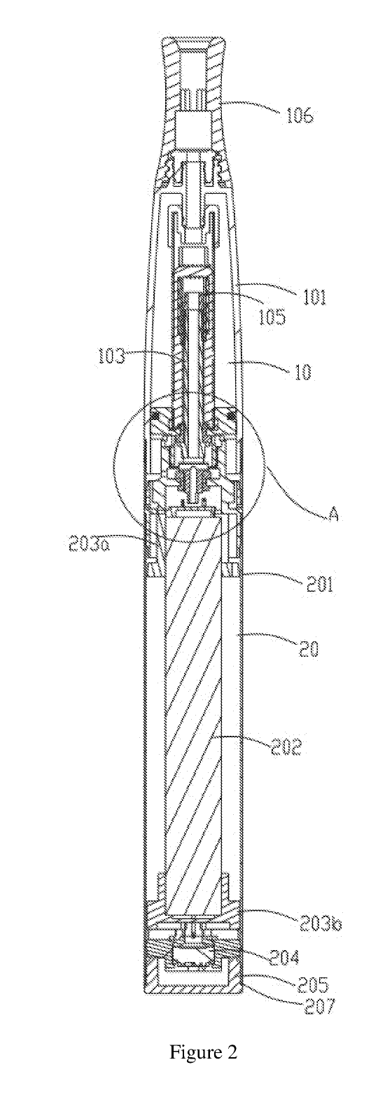

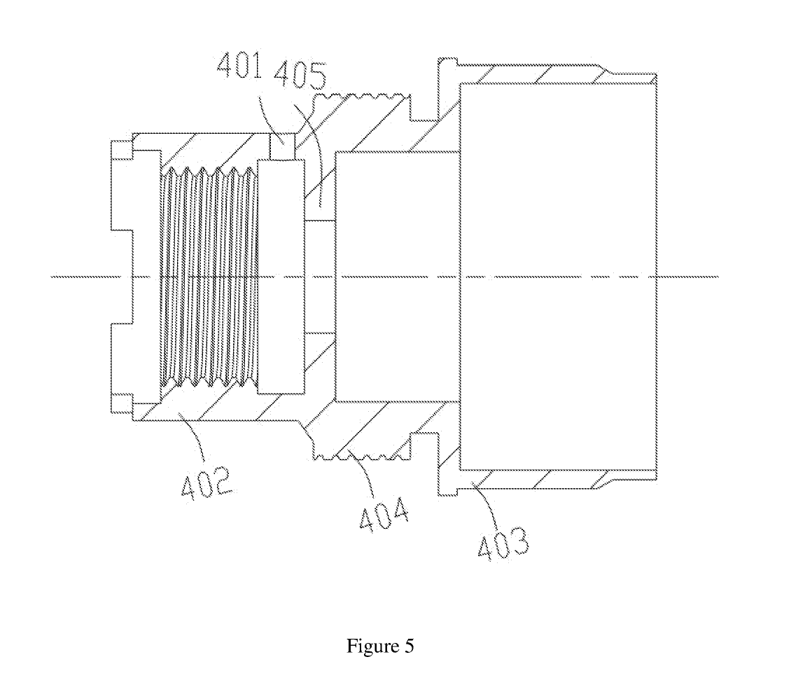

As shown in FIG. 2 to FIG. 5, the electronic cigarette provided in the present invention comprises the atomizer 10 and the battery stick 20 connected to the atomizer 10. The battery stick 20 is used for supplying power for the atomizer 10.

The atomizer 10 comprises an atomizer sleeve 101, a suction nozzle 106, an atomization component 105 and an upper electrode component. The atomizer sleeve 101 is approximately a hollow cylindrical structure. The atomization sleeve 101 and the suction nozzle 106 are connected with each other. In this embodiment, the atomization sleeve 101 and the suction nozzle 106 are detachably connected. The suction nozzle 106 is a ring structure, and it can be designed to be arc or conical. The texture and shape of the suction nozzle 106 are suitable for the users' mouth, and the suction nozzle 106 is made of soft material or wood material. The atomization component 105 is accommodated in the atomization sleeve 101 and is electrically connected to the upper electrode component. One end of the atomizer sleeve 101 is detachably connected to the suction nozzle 106, the other end of the atomization sleeve 101 is sealed with the upper electrode component.

The upper electrode component comprises a first upper electrode 103, a second upper electrode 104 and an insulation ring which is used for electrical insulation for the first upper electrode 103 and the second upper electrode 104. When the atomizer 10 and the battery stick 20 are connected, the first upper electrode 103 and the second upper electrode 104 are electrically connected to the anode and the cathode of the battery in the battery stick 20 respectively to realize supplying power for the atomization component 105.

The second upper electrode 104 is approximately a cylindrical structure, and comprises a clamp part 104a and an upper connection part 104b. The clamp part 104a is a ring structure, and is clamped at one end of the atomization sleeve 101 far away from the suction nozzle 106 and is used for sealing the atomization sleeve 101; the upper connection part 104b is used for connecting to the battery stick 20 to assembly the electronic cigarette. In this embodiment, the upper connection part 104b is provided with external thread, the upper connection part 104b and the battery stick 20 are threaded connected. It can be understood, the connection of the upper connection part 104b and the battery stick 20 can be clamping, tight fitting and magnetic.

The first upper electrode 103 is approximately a cylinder extended along the axial of the atomizer 10, and extends to the hollow portion of the atomization sleeve 101. An air flow channel 102 which is used for the smoke flow formed by atomizing from the atomization component 105 is formed at the center of the first upper electrode 103 along the axial of the first upper electrode 103. The air flow channel 102 is communicated with the suction nozzle 6 for users to inhale. The air flow channel 102 is axially through the first upper electrode 103. In this embodiment, the non-vaporized smoke oil in the atomization component 105 can fall through the air flow channel 102 under the influence of its own gravity.

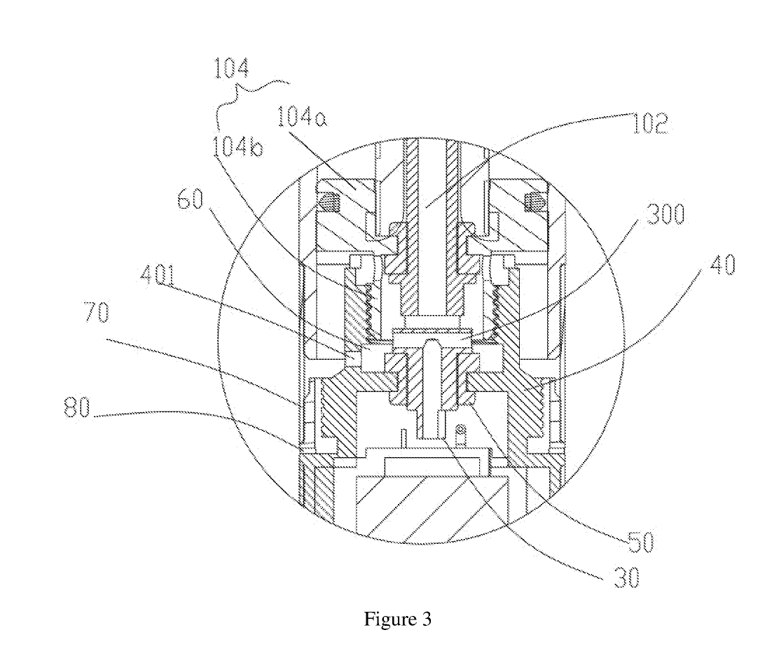

As shown in FIG. 3 to FIG. 5, and referring to FIG. 2, the battery stick 2 comprises a battery sleeve 201, a lower electrode component, an air inlet hole 207, a battery 202, a battery support (not labeled), an atomization control unit 204, and a light emitting device 205. The battery sleeve 201 is approximately a hollow cylindrical structure, and is coaxially arranged with the atomization sleeve 101. One end of the battery sleeve 201 far away from the atomizer 10 is provided with the air inlet hole 207, which is used for producing air flow when smoking. In this embodiment, the light emitting device 205 is arranged at the end of the battery sleeve 201 far away from the atomizer 10. The battery 202 is installed in the battery sleeve 201 by the battery support and is located between the lower electrode component and the light emitting device 205. The atomization control unit 204 is accommodated in the battery sleeve 201 and is located between the battery 202 and the light emitting device 205. The atomization control unit 204 is electrically connected to the battery 202.

The battery support comprises an upper support 203a and a lower support 203b, the upper support 203a and the lower support 203b are both mounted in the battery sleeve 201. The upper support 203a adjoins the lower electrode component and is clamped in the battery sleeve 201. The lower support 203b is located at an end far away from the electrode component. The upper support 203a and the lower support 203b are arranged coaxially, the battery 202 is clamped between the upper support 203a and the lower support 203b.

The light emitting device 205 is used as the working instruction lamp of the electronic cigarette, and comprises a light emitting unit 205a electrically connected to the battery 202 and a lamp cover 205b covered on the external of the light emitting unit 205a. The lamp cover 205b and the battery sleeve 201 are detachably connected. An air inlet hole 207 communicated with the vent channel 300 is arranged at this joint, so that an air flow path through the battery sleeve 201 can be formed in the battery sleeve 201.

The atomization control unit 204 comprises an atomization controller 204a which is electrically connected to the battery 202 and is used to power on or power off the atomizer 10, and controller installation base 204b. The controller installation base 204b is used for mounting the atomization controller 204a in the battery sleeve 201.

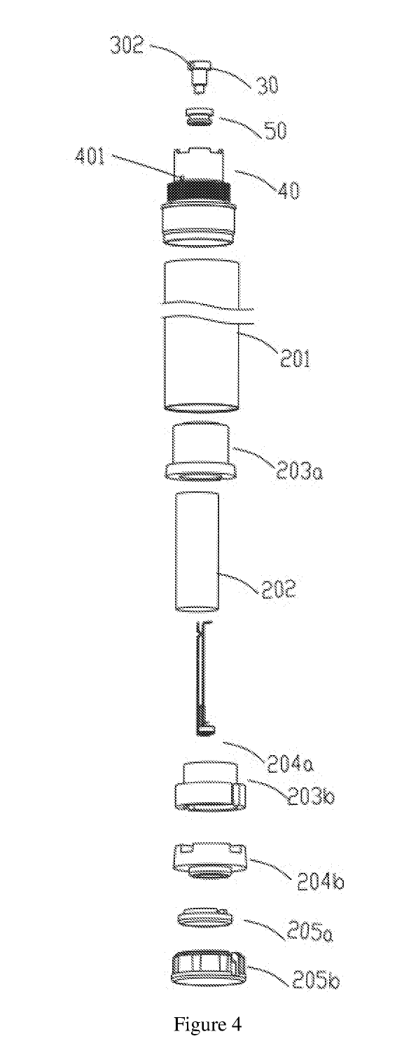

As shown in FIG. 2 and FIG. 4, the lower electrode component comprises a second lower electrode 40, a first lower electrode 30 which is through the interior of the second lower electrode 40, and an insulation ring 50 which is arranged between the first lower electrode 30 and the second lower electrode 40 and used for electrical insulation for the first lower electrode 30 and the second lower electrode 40. In this embodiment, the second lower electrode 40 is a hollow cylindrical structure (or other cylindrical structure), and is coaxially arranged with the second upper electrode 104. The second lower electrode 40 comprises a first connection part 402, a second connection part 403, and a third connection part 404 between the first connection part 402 and the second connection part 403. Internal thread is arranged on the inner wall of the first connection part 402, and is used for threaded connection to the upper connection part 104b of the second upper electrode 104 of the atomizer 10. The second connection part 403 is connected to the battery sleeve 201 by interference fit. External thread is arranged on the third connection part 404, and is used for connecting to the atomizer of other structures to expand the application range of the battery stick 20 and increase the versatility. But the third connection part 404 is not connected to other parts in this embodiment. In this embodiment, the second lower electrode 40 is in shape of stepped cylinder. The diameter increases successively from the first connection part 402 to the second connection part 403. A catch part 405 is extruded along a circle of the inner wall of the second lower electrode 40 facing the center line, and is used to catch the insulation ring 50. In this embodiment, the catch part 405 is a catch ring formed by surrounding the inner wall of the second lower electrode 40. The insulation ring 50 is through the middle through-hole of the catch ring and is caught with the through-hole. An oil storage gap 60 which is used for storing non-vaporized smoke oil is formed after the insulation ring 50 and the through-hole are caught. The side wall of the second lower electrode 40 is provided with an oil discharge hole 401 communicated with the oil storage gap 60. The oil discharge hole 401 is used for discharging the non-vaporized smoke oil in the oil storage gap 60. This kind of structure can prevent the smoke oil stored in the pipe to cause damage to the pipe wall. In this embodiment, the oil discharge hole 401 is arranged at a side wall of the first connection part 402 near the third connection part 404. So the fallen non-vaporized smoke oil can be directly discharged to the outside of the second lower electrode 40, and thus can be prevented to be stored in the second lower electrode 40 for too long and to damage the internal structure of the second lower electrode 40. In other embodiments, the oil storage gap 60 can be not arranged but the oil discharge hole 401 can be directly communicated with the air flow channel 102.

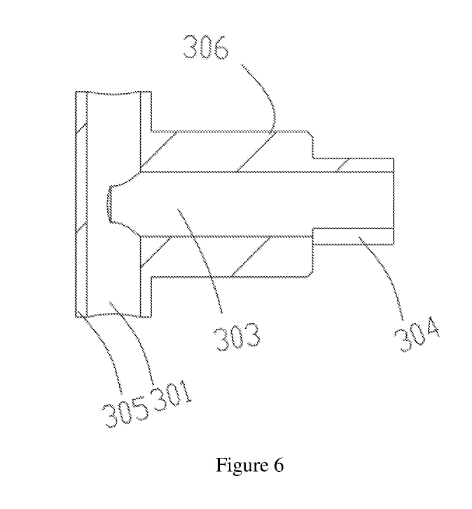

As shown in FIG. 2, FIG. 3 and FIG. 6, the first lower electrode 30 is approximately in shape of stepped cylinder, and comprises a head part 305 and a lower connection part 306 fixedly connected to the head part 305. The diameter of the head part 305 is larger than that of the lower connection part 306. The lower connection part 306 is through the center hole of the insulation ring 50 and is fixed at the center hole. The first lower electrode 30 is provided with a vent channel 300 communicated with the air flow channel 102 and the air inlet hole 207. The air inlet 304 of the vent channel 300 is communicated with the air inlet hole 207, the air outlet 302 is communicated with the air flow channel 102. The air outlet 302 is arranged at the side of the first lower electrode 30. Specifically, the air outlet 302 is arranged at the side of the head part 305. The vent channel 300 comprises a first lower vent channel 301 which is formed by extending along the opposite side of the air outlet 302, and a second lower vent channel 303 which is communicated with the first lower vent channel 301 and extended to the bottom of the first lower electrode 30. The second lower vent channel 303 is communicated with the air inlet hole 207. In this embodiment, the first lower vent channel 301 is radially arranged along the head part 305, and is through the side of the head part 305 radially. The second lower vent channel 303 extends from the joint of the head part 305 and the lower connection part 306 to the bottom of the first lower electrode 30 along the first lower electrode 30 axially. The notch formed at a side wall of the lower connection part 306 of the first lower electrode 30 is as the air inlet 304. This formed air inlet 304 can be directly communicated with the air path in the battery sleeve 201, which is convenient for the air flow. The top face of the head part 305 (facing to the end face of one end of the atomizer 10) is a closed plane. A smoke oil blocking face is formed for blocking the non-vaporized smoke oil fallen from the air flow channel 102, in order to prevent the non-vaporized smoke oil entering the vent channel 300. When the fallen non-vaporized smoke oil gather to a certain amount, under the influence of its gravity, the smoke oil will flow down to the oil storage gap 60 and be discharged through the oil discharge hole 401. The advantage of applying this kind of structure is to prevent the non-vaporized smoke oil entering the internal of the battery stick through the vent channel. In this embodiment, the oil storage gap 60 can be not arranged, but the oil discharge hole 401 can be obliquely extended along one side of the bottom of the battery stick 20, thus the fallen smoke oil can be directly discharged. In this embodiment, the distance between the oil discharge hole 401 and the atomizer 10 is larger than the distance between the air outlet 302 and the atomizer 10. The advantage of this kind of structure is preventing the smoke oil in the oil storage gap 60 entering the air outlet 302.

The battery stick 20 and the atomizer 10 are connected with each other by the second upper electrode 104 and the second lower electrode 40. A decoration sleeve 70 is arranged on a joint between the atomizer 10 and the battery stick 20. The decoration sleeve 70 makes the atomization sleeve 101 and the battery sleeve 201 axially coplanar, to promote the hand feel and the appearance of the electronic cigarette. By applying the decoration sleeve 70, the second upper electrode 104 and the second lower electrode 40 are both accommodated in the decoration sleeve 70 to be well protected. An oil discharge gap 80 is formed between an end face of the decoration sleeve 70 near the battery stick 20 and the top surface of the second connection part 403 of the second lower electrode 40. The oil discharge gap 80 is communicated with the oil discharge hole 401 and is used for discharging the non-vaporized electronic cigarette oil in the oil discharge hole 401 to the outside of the decoration sleeve 70.

The working principle of the electronic cigarette of the present invention will be explained in detail in the following.

When using this electronic cigarette, aiming at the suction nozzle 106 to inhale, the external air enters to the battery sleeve 201 through the air inlet hole 207 which is arranged at the joint of the lamp cover 205b and the battery sleeve 201. After flowing out along the gap between the inner wall of the battery sleeve 201 and the battery 202, the air enters the vent channel 300 of the first lower electrode 30 through the air inlet 304. When flowing through the atomization component 105 of the atomizer 10, the airflow will drive the smoke atomized by the atomization component 105 to flow to the direction of the suction nozzle 106. The smoke will flow out with the airflow from the suction hole through the air flow channel 102, and then will be inhaled by human eventually. But when the atomization component 105 is atomizing, part of the non-vaporized smoke oil or part of the non-vaporized smoke oil which is leaked when the atomization component 105 is not working will gather. When the non-vaporized smoke oil gathers to a certain amount to form droplets, under the influence of its gravity, the non-vaporized smoke oil will fall on the oil-blocking face of the first lower electrode 30 through the air flow channel 102, then fall in the oil storage gap 60 through the air flow channel 102, and be discharged through the oil discharge hole 401 eventually. Applying the battery stick 20 provided in the present invention can prevent the non-vaporized smoke oil falling to the interior of the battery stick 20.

It should be understood that, for those skilled in the art may make modifications or alternatives according to above instructions, and all these modifications or alternatives are belong to the protection of the present invention.

What is claimed is:

1. A battery stick, used to form an electronic cigarette with an atomizer (10); one end of the battery stick (20) is provided with an air inlet hole (207); the other end of the battery stick (20) is provided with a first lower electrode (30) used for electrically connecting to the atomizer (10); the first lower electrode (30) is provided with a vent channel (300) in communication with the air inlet hole (207);
wherein an air inlet (304) of the vent channel (300) is in communication with the air inlet hole (207); an air outlet (302) of the vent channel (300) is arranged on a side of the first lower electrode (30); an oil-blocking surface is formed on top surface of the first lower electrode (30); the oil-blocking surface is used for preventing non-vaporized electronic cigarette oil in the atomizer (10) from entering the vent channel (300).

2. The battery stick according to claim 1, wherein the vent channel (300) comprises a first lower vent channel (301) which is formed by extending along the opposite side of the air outlet (302), and a second lower vent channel (303) which is communicated with the first lower vent channel (301) and extended to the bottom of the first lower electrode (30); the second lower vent channel (303) is communicated with the air inlet hole (207).

3. The battery stick according to claim 1, wherein the battery stick further comprises a second lower electrode (40) which is arranged on outside of the first lower electrode (30), and an insulation ring (50) which is arranged between the second lower electrode (40) and the first lower electrode (30); an oil discharge hole (401) is arranged on the second lower electrode (40) and is communicated with the vent channel (300); the oil discharge hole (401) is used for discharging the non-vaporized electronic cigarette oil.

4. The battery stick according to claim 3, wherein, an oil storage gap (60) is formed between the insulation ring (50) and the second lower electrode (40); the oil storage gap (60) is used for storing the non-vaporized electronic cigarette oil; the oil storage gap (60) is communicated with the oil discharge hole (401).

5. The battery stick according to claim 4, wherein a distance between the oil discharge hole (401) and the atomizer (10) is larger than a distance between the air outlet (302) and the atomizer (10).

6. The battery stick according to claim 5, wherein the battery stick further comprises a battery sleeve (201) and a battery (202) which is accommodated in the battery sleeve (201); the battery sleeve (201) is fixedly connected to the second lower electrode (40); the battery (202) is electrically connected to the first lower electrode (30).

7. The battery stick according to claim 6, wherein the battery stick further comprises a battery support; the battery (202) is fixed in the battery sleeve (201) by the battery support.

8. The battery stick according to claim 6, wherein the second lower electrode (40) is a hollow cylindrical structure; a catch part (405) is formed along a circle of an inner wall of the second lower electrode (40) and used to catch the insulation ring (50); the catch part (405) and the insulation ring (50) are caught with each other and form the oil storage gap (60); the oil discharge hole (401) is arranged on a side wall of the second lower electrode (40) and is communicated with the oil storage gap (60).

9. The battery stick according to claim 8, wherein the second lower electrode (40) further comprises a first connection part (402) which is connected to the atomizer (10), a second connection part (403) which is connected to the battery sleeve (201), and a third connection part (404) between the first connection part (402) and the second connection part (403); the oil discharge hole (401) is arranged on an end of the first connection part (402) near the third connection part (404).

10. The battery stick according to claim 6, wherein the battery stick further comprises a light emitting device (205) which is arranged on an end of the battery sleeve (201) away from the atomizer (10).

11. The battery stick according to claim 6, wherein the battery stick further comprises an atomization control unit (204) which is arranged in the battery sleeve (201) and is used to power on or power off the atomizer (10).

12. An electronic cigarette, comprises an atomizer (10) and a battery stick (20) which is connected to the atomizer (10), wherein the battery stick (20) is the battery stick (20) in claim 1.

13. The electronic cigarette according to claim 12, wherein the electronic cigarette further comprises a decoration sleeve (70) which is arranged on a joint between the atomizer (10) and the battery stick (20); an oil discharge gap (80) is formed between an end face of the decoration sleeve (70) near the battery stick (20) and the battery stick (20), and is used for discharging the non-vaporized electronic cigarette oil from the decoration sleeve (70).

14. The electronic cigarette according to claim 12, wherein the atomizer (10) further comprises a first upper electrode (103) which is connected to a first lower electrode (30); the first upper electrode (103) is accommodated in an atomization sleeve (101); an air flow channel (102) is formed inside the first upper electrode (103) and is communicated with a vent channel (300).

15. The electronic cigarette according to claim 14, wherein the atomizer (10) further comprises a second upper electrode (104) which is arranged on the outside of the first upper electrode (103) and is electrically insulated with the first upper electrode (103); the second upper electrode (104) is detachably connected to the battery stick (20).

16. An electronic cigarette, wherein the electronic cigarette comprises an atomizer (10) and a battery stick (20), one end of the battery stick (20) is provided with an air inlet hole (207); the other end of the battery stick (20) is provided with a first lower electrode (30) used for electrically connecting to the atomizer (10); the first lower electrode (30) is provided with a vent channel (300) in communication with the air inlet hole (207); an air flow channel (102) is formed inside the atomizer (10) and is used for air flow, the air flow channel (102) is communicated with the vent channel (300);
an air inlet (304) of the vent channel (300) is in communication with the air inlet hole (207); an air outlet (302) of the vent channel (300) is arranged on a side of the first lower electrode (30); the vent channel (300) comprises a first lower vent channel (301) which is formed by extending along the opposite side of the air outlet (302), and a second lower vent channel (303) which is communicated with the first lower vent channel (301) and extended to the bottom of the first lower electrode (30); the second lower vent channel (303) is communicated with the air inlet hole (207);
an oil-blocking surface is formed on top surface of the first lower electrode (30); the oil-blocking surface is used for preventing non-vaporized electronic cigarette oil in the atomizer (10) from entering the vent channel (300).
